(19) United States
(12) Patent Application Publication
(10) Pub. No.: US 2009/0327921 A1
(43) Pub. Date: Dec. 31, 2009

(54) ANIMATION TO VISUALIZE CHANGES AND INTERRELATIONSHIPS

(75) Inventors: Morten Holm-Peterson, Gentofte (DK); George G. Robertson, Seattle, WA (US); William G. Morein, Cambridge, MA (US); Jason J. Weber, Kirkland, WA (US); Danyel Aharon Fisher, Seattle, WA (US); Gur Kimchi, Bellevue, WA (US); Benjamin Edward Rampson, Redmond, WA (US); Ahmed K. Kamal, Bellevue, WA (US); Kipper Jewsbury, Seattle, WA (US); Benjamin L. Chronister, Duvall, WA (US); Roland L. Fernandez, Woodinville, WA (US); Christian Olaf Abeln, Odakra (SE); B. Scott Ruble, Bellevue, WA (US); Stella Yick Chan, Redmond, WA (US); Murali R. Krishnan, Bellevue, WA (US); Brian L. Welcker, Seattle, WA (US); Bongshin Lee, Issaquah, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/163,608

(22) Filed: Jun. 27, 2008

(51) Int. Cl. G06F 3/00

(52) U.S. Cl. 715/753

(57) ABSTRACT

Modifications to a collection of data are maintained in chronological order and selectively rendered as a function of time. The selective rendering can include an animated version of the modification, which can include a timeline of events. The modifications can be associated with related data that includes information as to who made the modification, when the modification was made, and so forth. The related data can also include a motivation behind the modification. Further, confidence information can be related to the modification to add further detail to the modifications and events surrounding the collection of data.

### BACKGROUND

Today, people utilize computing devices to perform a vast amount of information location and retrieval tasks. In fact, it is common for a multitude of different types of data to be retained electronically for ease of retrieval and accessibility. Such electronic retention of data can mitigate the need for physical copies of the data, which can reduce the amount of storage space needed.

Data that are related to each other can be captured and retained as a single file (or data set), similar to a file folder in which the physical copies of the data (e.g., paper documents) might have been stored. In addition, as data in the data set is modified, new data can simply be captured and appended to the existing file or, in some cases, retained as a different file.

When information contained in the file (or the multiple files) is desired, the entire file has to be reviewed by systematically looking at each portion of the file, which is similar to flipping though each page in the paper copy file folder (e.g., physical file). This can be time consuming and important modifications to the file and other data can be missed by scrolling though the document too fast or losing interest in the task of looking for particular information.

In some cases, information relating to the data or modifications to the data, such as reasons for the modifications, the person making the modifications, or other information is not retained with the files. Thus, in most cases, this information is not retrievable and a timeline of events (e.g., a time sequence) cannot be properly recreated. Therefore, insight into a current state of the data cannot be easily obtained.

### SUMMARY

The following presents a simplified summary in order to provide a basic understanding of some aspects of the disclosed examples. This summary is not an extensive overview and is intended to neither identify key or critical elements nor delineate the scope of such aspects. Its purpose is to present some concepts in a simplified form as a prelude to the more detailed description that is presented later.

In accordance with one or more examples and corresponding disclosure thereof, various aspects are described in connection with a collaborative set of data that, from conception to completion, might be modified numerous times by more than one person. Each person contributing to the set of data might not be aware of some of the changes made by others and also might not be aware of the reason the change were made. This innovation provides visualization and animation of the modifications made to a set of data over the life of that data. Animation is utilized to visually provide information related to change tracking. For example, a sales quote and/or sales order might have been revised a number of times before the final product ships to a customer. When the product arrives at the customer's site, it is determined that the product received was not what was ordered. The provided change tracking visualization can illustrate the different people that made changes to the order, when the changes were made, reasons for the changes, and so forth. Thus, the changes can be visualized over time and can be reviewed to determine the collaboration and items that caused a particular change.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the various aspects may be employed. Other advantages and novel features will become apparent from the following detailed description when considered in conjunction with the drawings and the disclosed examples are intended to include all such aspects and their equivalents.

### BRIEF DESCRIPTION OF THE DRAWINGS

FIG. 1 illustrates a system that facilitates comprehension of a sequence of modifications to a data set.

FIG. 2 illustrates an example alternative block diagram of system that includes a data change tracking system to facilitate comprehension of a sequence of modifications.

FIG. 3 illustrates another example alternative block diagram of system that includes a data change tracking system to facilitate comprehension of a sequence of modifications.

FIG. 4 illustrates a methodology of representing data changes as a sequence of animated events in accordance with an aspect.

FIG. 5 illustrates a methodology for dynamically capturing and storing modifications to a subset of data.

FIG. 6 is an example implementation of modifications to a collection of data that are represented as a function of time in accordance with one or more aspect presented herein.

FIG. 7 is another example implementation in accordance with one or more of the disclosed aspects.

FIG. 8 illustrates a representation of two users visualizing a similar data animation in accordance with the disclosed aspects.

FIG. 9 illustrates a block diagram of a computer operable to execute the disclosed architecture.

FIG. 10 illustrates a schematic block diagram of an exemplary computing environment in accordance with the various aspects.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

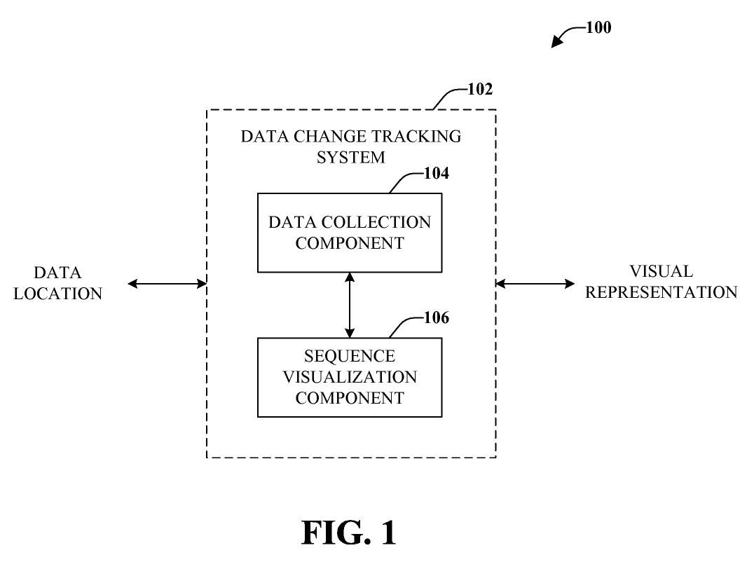

FIG. 1 illustrates a system 100 that facilitates comprehension of a sequence of modifications to a data set. As used herein “data set” can be any type of data that can be created, modified, stored, and/or destroyed (e.g., deleted, removed from the data set). Examples of data in a data set include, but are not limited to: text, databases, documents, charts, graphs, files, pictures, video, spreadsheets, reports, audio, or combinations thereof. The term “modification” refers to any type of changes that are made (e.g., additions, deletions, comments, and so forth) to the data or a subset of the data (e.g., text deleted from a portion of a text document, relationships within an ancestry tree altered due to a divorce and a remarriage). Further the terms “modification”, “change” and the like are used interchangeably herein.

Over time, data within the data set, which can be a collaboration of data, can be modified by various users. The modifications, as well as the reasoning behind the modifications, might not be readily apparent or understandable when the data contained in the data set is utilized or relied on by the users that made modifications as well as others that are reviewing the data contained in the data set. In some situations, history of an event can be represented as animation of data corresponding to that event to facilitate comprehension of the current state of the event or how/why a particular result happened.

System 100 provides a visualization of the modifications that can be represented as a function of time in response to a data request. Time can be represented as animations of the modifications, the modifications can be represented along a time based animation (e.g., timeline), and/or other renderings of the modifications that provide ease of perceiving and understanding the modifications and the relationship to other data within the subset of data (e.g., whether a modification affected other data). In accordance with some aspects, system 100 allows portions of the data to be examined in detail for related information (e.g., identification of a person that made the modifications, reasons for the modification, confidence level of the data, and so forth).

In accordance with some aspects, the modifications can represent all information associated with the various stages of a data set, from conception to a final result. These various stages can be represented as interrelationship of the data. For example, for a sales organization, the data set can be the events that occur from an initial customer contact to receiving payment for a product. Thus, the data set can include data associated with cold calling a potential customer (e.g., phone record, client contact information), providing pricing information, following up with the customer a few days later, receiving an order for a product, shipping the product, generating an invoice, and receiving payment (e.g., completion of the sale). Each of these events can be represented as modifications that occur to the data set over time. The sequence of events, from the initial contact to receiving payment or another action (e.g., issuing credit, exchanging the product for another product, performing service or warranty work, and so forth), can be presented in an animated form to allow a user reviewing the history of the sale to visually experience the life-cycle of the sale (and potentially the life span of the product) as dynamic actions that occur over time. This can replace the need for the user to flip though a pile of documents contained in a folder, which can become lost or misplaced (e.g., damaged, physically removed).

In further detail, system 100 includes a data change tracking system 102 that enables a user to comprehend a collection of data from conception to final completion or a current state of the collection of data. The collection of data can be a collaborative database of information, a set of data, one or more documents, text and data, a voice file, a recorded action, or other data that can be collected and linked to other data (e.g., as associated data). Modifications to the collection of data can be tracked and cataloged and a visualization provided that illustrates the sequence of modifications.

Related information, such as the user(s) that made the change(s), a time of the change (e.g., based on a time stamp), can be associated with each modification. In accordance with some aspects, information related to why the modifications were made can be maintained with the tracked change(s). For example, the user making the modification can be provided the opportunity to enter comments (e.g., text comments, verbal comments), such as through a user interface.

Data change tracking system 102 includes a data collection component 104 that gathers modifications relating to a multitude of data. The data can be gathered (e.g., requested, periodically polled, automatically received) from one or more data locations (e.g. a data store, a storage medium, a computer readable media, a computer storage media, a server, as well as others). The data locations can be local to system 100 or can be remote from system 100 and accessed through various means (e.g., Intranet, Internet, and so forth). In accordance with some aspects, the data can be gathered directly from a user (e.g., through a user interface or other means of communicating directly with a user). Additionally or alternatively, the data can be gathered directly or indirectly from sensors and other types of devices. Thus, while the modifications are being made, the modifications (and supplied related data) can be dynamically gathered and applied to the data.

Also included in data change tracking system 102 is a sequence visualization component 106 that outputs the gathered modifications as a function of time in response to a data request. In accordance with the aspects that gather the modifications directly from the user, the modifications can be output at substantially the same time as the modifications are input by the user (e.g., the user can perceive the animation of the event as the event is occurring).

In accordance with some aspects, sequence visualization component 106 can represent deletions as a function of time by displaying the deleted data as moving out of a viewing range or fading out of view (e.g., deleted text appearing to becoming disjoint from other data and moving toward an edge of a screen and, eventually, out of view). In another example, sequence visualization component 106 can represent insertions as a function of time by displaying the inserted data as moving into a viewing range (e.g., a name/position of a new employee moving from a background to a front of a screen to an appropriate location in an organizational chart) or by displaying the inserted data as transitioning from transparent data to readily perceivable data (e.g., font becoming darker, font size becoming larger).

Further, sequence visualization component 106 can provide the visualization as data coming from a visual object that represents the source of the object. In another example, the data can be visualized as going to a visual object that represents the destination or disposal of the data (or object). Additionally or alternatively, for existing data this is adjusted/changed, sequence visualization component 106 can provide a visual object that represents the process or person that performs the change. The process or (virtual) person can be shown in the animation operating on the data being changed.

Combinations of time elements (e.g., insertions, deletions) can be represented at substantially the same time, depending on the speed of the animation. For example, when viewing a text document, in the location where an insertion is made, the existing text, graph, picture, table, and so forth, is deleted and presented as moving out of the way and new text (or other data) appears. In such a manner time is represented as new data replacing old data or appending to existing data (e.g., if no data is deleted or is deleted in a different portion of a document).

In accordance with some aspects, sequence visualization component 106 represents time through a time-based animation (e.g., a timeline) and, when a change at a particular point is viewed (e.g., user requests to see modifications made by a specific person or modifications made on a specific day), prior data (a day before the requested day) and/or more recent data (a day after the requested day, if available) can be viewed along the timeline by changing a focus (e.g., moving a slider) to a different position on the timeline.

According to some aspects, the time-based animation can be an animated timeline that is flexible. For example, the animated timeline can be linear wherein animation of changes can be selected in an animation speed that is proportional to real time (e.g., normal speed, slow speed, fast speed, and so forth). In another example, the animated timeline can be dynamic wherein the number of change events divided by the number of animation steps at animation time equals a constant (e.g., a constant time). Dividing the number of change events by the animation steps at animation time can distort the timeline from real time, thus making the time line linear to changes.

In accordance with some aspects, the animation timeline can be navigated with automatic and/or defined stop points. For example, a user can pause, wind back and/or wind forward in the animation timeline manually (e.g., navigatable). Additionally or alternatively, automatic navigation and defined stop points (e.g., by specific event or point in time) can be set, which can pause or stop the animation for a specific interval and/or until a manual input is received to continue the animation.

Thus, system 100 can present the modifications in a visualized, animated format to a user requesting data within the data (e.g., a subset of data). Each type of data is associated with an order or sequence, which can be thought of in terms of time, and the relationships between the data or a subset of the data (e.g., new pictures added to a slide show, rearrangements of pictures in the slide show) can be visualized over time based on the animation presented, which can allow a user to go backward in time as well as forward in time from a particular point within the data.

In accordance with some aspects, data change tracking system 102 can be configured to retain and/or access change description data that includes a description of the changes. Included in the change description data can be various information about the data, such as reason for the change, identification of the user(s) that made the change, and so forth.

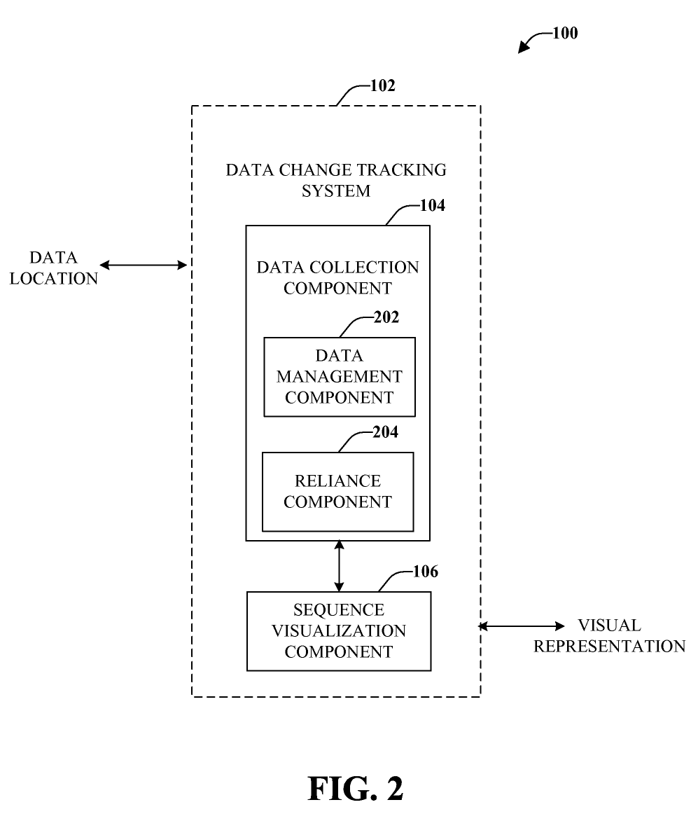

FIG. 2 illustrates an example alternative block diagram of system 100 that includes a data change tracking system 102. Included in data change tracking system 102 is a data collection component 104 that gathers modifications relating to a multitude of data, such as from one or more data locations. Also included in data change tracking system 102 is a sequence visualization component 106 that outputs the gathered modifications as an animated function of time in response to a request for a subset of data in the data set. Data collection component 104 can include a data management component 202 that captures and maintains a sequence of modifications to a collection of data. The sequence of modifications can span from conception of an event to a current state of the collection of data when a request to view the data is received.

To capture the sequence of modifications, that can occur over a period of hours, days, weeks, or years, data management component 202 can utilize different techniques for gathering the data. A technique includes identifying a set of data and requesting any modifications to the data (or a subset of data) be automatically sent to data management component 202. For example, data of different types or formats (e.g., audio file, text, document, spreadsheet, and so forth) can be identified by data management component 202 as belonging to a single data set Such identification can include establishing identifiers (e.g., metadata) that indicate the connection between the data in the data set. Modifications to the data identified as belonging to a data set, or new data added to the data set (e.g., a departmental monthly report for February added to the data set that includes the monthly report for January) are identified though the established identifiers. Based on the identification, the modification (e.g., new report) can be automatically sent to data management component 202 based on a previously defined request and data management component 202 can modify the sequence of modifications related to the data set. In accordance with some aspects, a piece of data can belong to more than one data set and identifiers for the multiple data sets can be established by data management component 202.

Another technique that can be utilized by data management component 202 to gather the modifications can be to periodically query data that is already included in a known data set. For example, data, such as an organizational chart, can be maintained locally on a user device. In order to obtain an updated version of the organizational chart, data management component 202 can periodically communicate with user device and request a latest version of the chart. In the absence of change description metadata, data management component 202 (or another system 200 component) can compare a previous version of the data with the new data and change description metadata can be generated based on the comparison.

According to some aspects, data management component 202 (or another system 200 component) can be configured to retain and/or access change description data that includes a description of the changes. Included in the change description data can be various information about the data, such as reason for the change, identification of the user(s) that made the change, and so forth. In such a manner, data management component 202 can mitigate a need to compute differences by comparison of the data at data access time (e.g., when a user requests the data).

In accordance with some aspects, another technique utilized by data management component 202 is to automatically receive data and modifications from a multitude of identified devices (e.g., devices maintained with a department or an entire company, devices associated with family members, and so forth). At substantially the same time as the data is received, data management component 202 can selectively determine whether the data should be retained or added to an existing data set, whether the data should be associated with a new data set, or whether the data should be discarded (e.g., not maintained with any data set).

The various aspects (e.g., in connection with data management) can employ various machine learning schemes (e.g., artificial intelligence, rules based logic, and so forth) for carrying out various aspects thereof. For example, a process for linking data within a dataset, can determine whether to maintain the data within a new data set or an existing data set, whether to discard received data can be facilitated through an automatic classifier system and process.

Artificial intelligence based systems (e.g., explicitly and/or implicitly trained classifiers) can be employed in connection with performing inference and/or probabilistic determinations and/or statistical-based determinations as in accordance with one or more aspects as described herein. As used herein, the term “inference” refers generally to the process of reasoning about or inferring states of the system, environment, and/or user from a set of observations as captured through events, sensors, and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, and so forth) can be employed in connection with performing automatic and/or inferred action in connection with the disclosed aspects.

Additionally or alternatively, data management component 202 can gather (e.g., receive, request, search) data related to a modification. Such data can be source data that can include an identity of a person that modified a subset of data, a day/time the modification was made, identification of a device from which a modification was received/obtained, and so forth. In accordance with some aspects, related data includes a motivation for the modifications. For example, at substantially the same time as a modification is made, a prompt can be presented to the user, through a user interface, for example, asking if the user would like to enter comments or further information relating to the modification. The user can selectively enter the information relating to the reason for the modification. In accordance with some aspects, the information related to the motivation for the modification is received before the modification is applied. Thus, if the motivation information is not supplied, the modification is not applied to the data.

Also included in data collection component 104 is a reliance component 204 that associates a level of confidence with the data or a subset of the data contained in the collection of data. The level of confidence can be expressed as a percentage or though other visual means (e.g., line thickness, shading, color scheme, zoom level of items, and so forth). According to some aspects, the reliance component 204 can track the confidence level supplied from two or more users for a similar data point. Additionally, each user that supplied a confidence level can provide reasons as to why that particular level was assigned.

In some situations, an action must be made during a stage of uncertainty, such as when material or product must be purchased (e.g., due to a long lead time for material needed to manufacture a product) based on a forecast or likelihood that an order for the product will be placed by a customer in order to comply with customer shipping requests, and so on. Thus, confidence levels from a multitude of different data and sources can be correlated to arrive at the determination that the material or product should be purchased prior to actually receiving the purchase order from the customer (e.g., prior to 100% confidence). The user can enter the confidence level and the reasons for that level so that later, if something changes, the reasons for the high (or low) confidence level can be ascertained. Thus, it can be important to know who supplied the confidence level as well as the reasons for that confidence level (e.g., what was occurring?).

As an example, a sales department in a medical equipment manufacturing company is assigning a confidence level of how likely a multi-million dollar sale will be made. At the early stages of the sales effort, the confidence level of completing the sale might be below 5%. However, when the sale is almost finalized, the confidence level raises to a 94% confidence of completing the sale. Thus, the related information associated with the data is a confidence level provided by one or more users.

According to some aspects, confidence information can be automatically generated by reliance component 204. The automatic generation of confidence information can be performed by aggregating confidence levels that have been entered manually (e.g., “we have a 60% chance of meeting the decision-maker and a 30% chance of the decision-maker choosing to purchase our product”). According to some aspects, different aggregation and filtering techniques can reduce (or increase) a certainty by different amounts, which can be based on a mathematical model instead of based on a manual input. Additionally or alternatively, automatic generation of confidence information can be performed by linking the confidence level to fixed and known stages in the process (e.g., “as a pre-sale, this is automatically a 5% confidence; after the first meeting, it is automatically a 10% confidence”). In accordance with some aspects, a confidence level is automatically generated based on a model or specification of a data source. For example, if the data is received from a hardware sensor, information known about that hardware sensor can indicate a specification that indicates the accuracy (e.g., resolution) and sampling rate. This information can be utilized to derive a confidence level on data from that sensor without manual input.

In accordance with some aspects, a timeline can be utilized in conjunction with the confidence level to show the modifications (e.g., sales efforts, client contact, price changes, specification alterations, and so forth) over time and how that relates to the confidence level. According to some aspects, instead of using a percentage to represent a confidence level other means can be utilized. For example, the thickness of a line can be narrowed when there is a convergence on what an expected level of confidence is at any point in time.

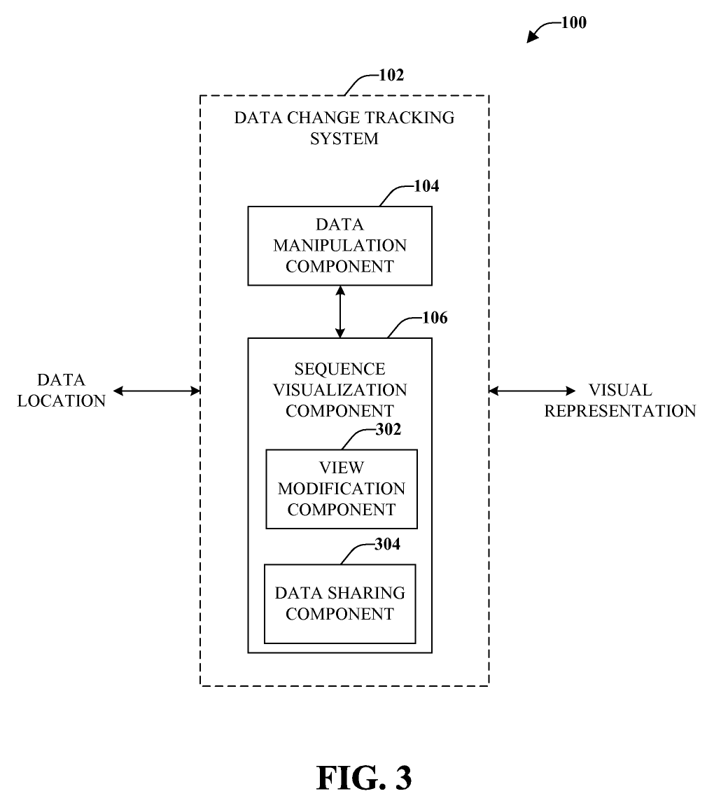

FIG. 3 illustrates an example alternative block diagram of system 100 that includes a data change tracking system 102. A data collection component 104 that gathers modifications relating to a collection of data and a sequence visualization component 106 that outputs the gathered modifications as an animated function of time in response to a request for a subset of data in the data set are included in data change tracking system 102.

In further detail, sequence visualization component 106 includes a view modification module 302 that can alter a view or animation. The playback speed of the animation can be modified so that portions with many modifications can be slowed down for easier comprehension and portions with few modification can be sped up. In accordance with some aspects, the speed of the animation can be chosen so that the life cycle of the data set is perceived over a given period of time. As such, the user can select the amount of time (e.g., 5 minutes) available for viewing the animation and view modification module 302 can automatically adjust the viewing speed to accommodate the user request.

In accordance with some aspects, sequence visualization component 106 can alter a format for representing the modifications. For example, a text document can be rendered on a display. The document can automatically scroll to a location where text is inserted to replace exiting text. The animation, as a function of time, can allow the user to perceive the old text moving out of the way and the new text appearing.

Sequence visualization component 106 can also allow the animation to be paused by the user. By pausing the animation the user can drill down into the data or modifications to the data. Pausing the animation can also allow the user to review any comments to the modification (e.g., the reasoning for the modification) as well as other related data (e.g., source data).

Also included in sequence visualization component 106 is a data sharing component 304 that allows two or more users to selectively share modifications and data. Each of the users can input modifications that are automatically presented to the other users. This collaboration allows multiple people to, at substantially the same time, perceive the data with different views and any changes made to the data (e.g., adding an annotation, changing a confidence level, and so on) are immediately available for viewing by the other people who may be looking at it from a different view or a different dimension.

In accordance with some aspects, each of the users can view (and maintain) information that is personal and not shared with the other users. For example, a purchaser wants to increase the quantity of a sales order and is discussing the pricing with a sales agent. Both the purchaser and the sales agent can see a shared view of certain information (e.g., specifications of the product). However, each can have information that is not shared with the other. Thus, the purchaser has information that is not able to be viewed by the sales agent and, likewise, the sales agent has information that is not viewable by the purchaser. If a price is agreed upon, that pricing and quantity information can be selected for the shared view, while maintaining data integrity of other information that is not shared (e.g., the profit made by the sales agent per piece, the maximum amount the purchaser was willing to pay).

The data change tracking system 102 can be operatively connected with various types of user interfaces such as a graphical user interface (GUI), a command line interface, a speech interface, Natural Language text interface, and the like, to allow a user to interact with system 102. For example, a GUI can be rendered that provides a user with a region or means to input modifications, request for data, and the like, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the information conveyance such as vertical and/or horizontal scroll bars for navigation and toolbar buttons to determine whether a region will be viewable can be employed.

The user can also interact with the regions to select and provide information through various devices such as a mouse, a roller ball, a keypad, a keyboard, a pen, gestures captured with a camera, and/or voice activation, for example. Typically, a mechanism such as a push button or the enter key on the keyboard can be employed subsequent to entering the information in order to initiate information conveyance. However, it is to be appreciated that the disclosed embodiments are not so limited. For example, merely highlighting a check box can initiate information conveyance. In another example, a command line interface can be employed. For example, the command line interface can prompt the user for information by providing a text message, producing an audio tone, or the like. The user can then provide suitable information, such as alphanumeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

In view of the exemplary systems shown and described above, methodologies that may be implemented in accordance with the disclosed subject matter, will be better appreciated with reference to the following flow charts. While, for purposes of simplicity of explanation, the methodologies are shown and described as a series of blocks, it is to be understood and appreciated that the disclosed aspects are not limited by the number or order of blocks, as some blocks may occur in different orders and/or at substantially the same time with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

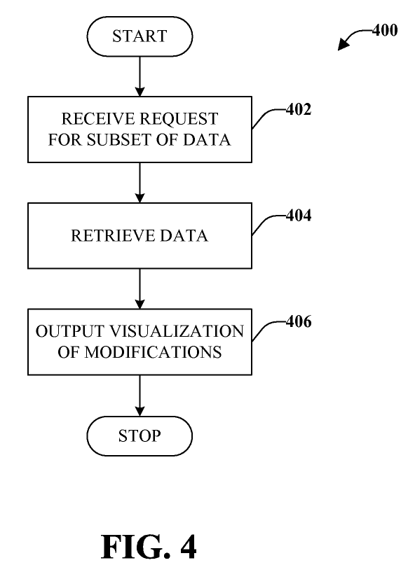

FIG. 4 illustrates a methodology 400 of representing data changes as a sequence of animated events in accordance with an aspect. Method 400 can provide a animated version of a collection of data over the life cycle of that data while allowing a user to visually perceive the interrelationships of the data.

At 402, a request for a subset of data is received. This request can be provided in various forms, such as for a particular form of data (e.g., document, chart, file, text, graph, and so forth), for a particular person that made a change, for a particular day, or for other data (e.g., data relating to key words or key phrases, title of a project, and so on). The request can be received from one user or from multiple users at substantially the same time (e.g., a collaborative event) or at different times.

The requested subset of data is accessed or retrieved, at 404, from a database, storage media, and/or other location, whether a local source, a remote source, or from both local and remote sources. For example, a request can be received for the entire chain of events or a snapshot in time for the event. Based on this request, the data can be accessed. In accordance with some aspects, if only a snapshot of the data is requested, the linked data within the data set can also be retrieved in anticipation of the user requesting more data after perceiving the snapshot, thus mitigating the amount of wait time for the additional data.

At 406, a visualization of the data and changes are presented to the user(s). The visualization can be in the form of animations that visually represent the modifications (e.g., deleted data moving or fading out of view, added data moving or fading into view, data growing, shrinking, or being otherwise modified). In accordance with some aspects, a subset of the visualization is shown to multiple users while a different subset of the data is personalized for each user. In accordance with some aspects, the visualization can also be in the form of a timeline that allows a user to selectively transition to previous versions or more recent versions of the data as a function of the location of the data currently being viewed.

In an example, a person in an accounts payable department is preparing to pay an invoice; however, that person believes the invoice is a duplicate invoice. By requesting and reviewing a visual history of what has happened, it might be determined that a quote was provided for meeting room tables and chairs and then a second quote for a different quantity of tables and chairs was provided. An order was placed based on the second quote; however, the type of table ordered was different from the quoted table. A few days later, the order is changed to a higher quantity (e.g., more tables and chairs) since more people have confirmed that they will be in attendance at the meeting. As a result of this, a second purchase order is created to reflect the quantity increase. The original purchase order (for the lower quantity) was paid but now the payment for the increased quantity (e.g., potential duplicate invoice) is due. Allowing the person responsible for paying the invoice to view the history in an animated and cohesive manner assists in facilitating comprehension of why another payment is necessary (e.g., due to the increased quantity).

In another example, when a data set is presented visually, a change can be selected, such as by clicking on the change with a pointing device (e.g., mouse, selector) or through other means associated with a user interface. Selecting the modification can provide information such as the identity of the person that made the modification, the reason for the modification, or other information. If the identity of the person that made the modification is selected, such as by selecting the person's name or though other means, other changes made by that person can be highlighted or displayed in such a manner that attention is brought to the modification. This might be desirable to determine if the person making the modification had an incorrect idea about what was needed and made multiple modifications according to an incorrect mental model of the world while, at substantially the same time, a second person is making other changes (e.g., fixing the changes made by the first person that was incorrect). In such a manner, being able to track who did what, when it was done, and why it was done is helpful to understand the final result or a current result being viewed. Animation further facilitates this by allowing the user to dynamically visualize the modification rather than reviewing a multitude of documents within a file.

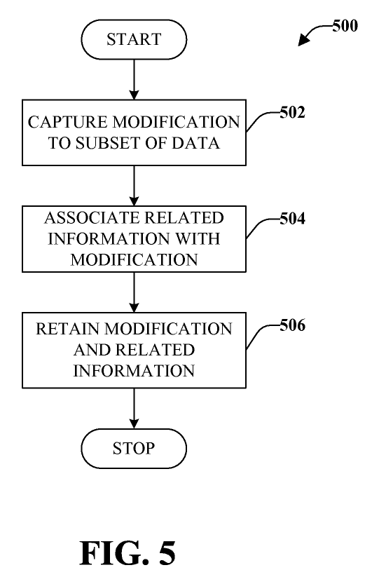

FIG. 5 illustrates a methodology for dynamically capturing and storing modifications to a subset of data. The modification can be made to data that is rendered in accordance with the methodology of FIG. 4 or that is rendered through other means.

At 502 a modification to a subset of data is captured. The modifications can be any annotations and/or changes to the data (e.g., additions, deletions, and so forth). The modification can be captured when the modification is automatically received, such as if associated data in a data set has been identified and any information relating to that association has been requested. The modification might be captured based on a specific request for the information.

At 504, related information can be associated with the modification. This related information can include source information, such as the location of the data, the identity of the user(s) that modified the data, whether this data is linked to other data sets, and so forth. The related data can be annotations, which can be any comments, remarks, or extra information that would be useful for someone viewing the changes at a later time. Multiple types and any number of related information can be associated with one or more modifications. Any number of users can add information to the same or a similar subset of data. For example, a first user can make changes that are further changed by a second user. A third user returns the data to its original version before modification by the first user. Then, this latest version (which is substantially the same as the original version) is subsequently changed by a fourth user. Each of these modifications is maintained within the historical information associated with the data set (e.g., in chronological order). Thus, any combination of one or more of the reason(s) for the modification, the identity of the user that made the change, annotations, and the day/time the modification was made can be associated with the particular modification and subset of data.

The related data can also include a level of confidence that a user has in the data at any point in time during the life cycle of the data set. In accordance with some aspects, the related data include a motivation surrounding the modification (e.g., why the change was made, what prompted the need for the change, and so forth). According to some aspects, the level of confidence can be automatically generated based on an aggregation of confidence levels that have been manually entered. Additionally or alternatively, the automatic generation of confidence can be based on linking the confidence level to fixed, known stages associated with the subset of data and/or based on a model or specification associated with a data source.

At 506, the modifications and related data are maintained in a storage media. Multiple versions of a subset of data can be maintained in order to provide an animated history of the data in accordance with the various aspects presented herein. For example, a modification to a video can include edits to either or both a visual portion and an audio portion. As the changes are made, such as adding scenes, the added scenes are retained as a newer version of the video. Subsequent changes (e.g., modifications, additions, deletions, or other changes) are maintained as newer versions of the video, without replacing the previous version(s).

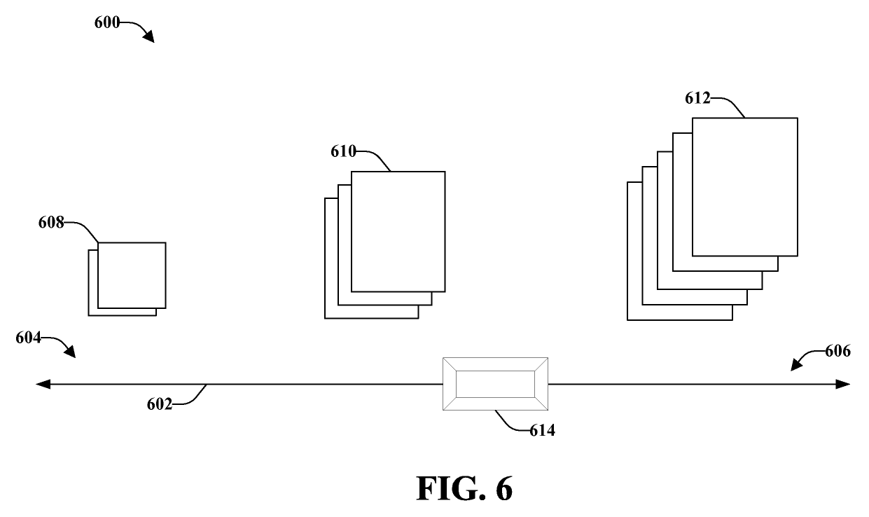

FIG. 6 is an example implementation 600 of modifications to a collection of data that are represented as a function of time (e.g., time-based animation) in accordance with one or more aspects presented herein. As illustrated, a timeline 602 can be rendered, such as by a sequence visualization component. The timeline 602 is flexible and navigatable and can represent events that are near a conception stage (e.g., past events) at a first end 604 and more current events at a second end 606. As changes to data occur, the data can be represented as a historical progression from the first end 604 to the second end 606.

As illustrated, a first set of data, illustrated as two documents 608, is near the beginning of the timeline 604. The two documents 608 can represent a quotation for material and a purchase order. Over time, more documents can be added, as illustrated at 610. These documents can represent the quotation, the purchase order and a bill of lading (or shipping paperwork). At a later or more current time, as illustrated at 612, the documents representing the collection of data can include the quotation, the purchase order, the bill of lading, an invoice, and a payment, which can be in the form of a check and associated check stub.

It should be understood that each of the documents can be added to the timeline individually. Thus, close to the first end 604 of the timeline 602, there can be one document that represents a quotation. At a next point, moving towards the second end 606 of the timeline 602 a second document can be added, which can represent the purchase order. Further along the timeline 602 moving toward the second end 606 can be the bill of lading, and so forth.

In accordance with some aspects, various techniques can be utilized to illustrate data, such as documents, being added (or deleted) from the timeline. For example, documents can be transparent and gradually become more solid. In another example, a color scheme or shading can be utilized to represent documents being added and/or deleted. Visual representations can also be provided that illustrate changes within a document or data.

In accordance with some aspects, elements on the timeline can include bar charts that indicate the number of modifications added, number of modifications subtracted plus comments or other related information. According to some aspects, the elements can include thumbnails of the data with highlighted sections showing where the changes were made.

Represented along the timeline 602 is a slider 614 that can be utilized by a user to move from conception 604 to completion (or a current state) 606. As illustrated, the slider 614 is at a position on the timeline 602 and data to the left (toward the first end 604) can represent the data at a time prior to the gathered modification (e.g., past events) and points to the right (toward the second end 606) can represent the data at a time after the gathered modification (e.g., future events) with respect to the point on the timeline 602 being examined.

For example, data can be presented to the user as data points on a timeline. The user can select different points of time within the life cycle of that data set, such as by moving a slider or selector associated with the timeline. The data modifications can be presented as a function of the relative location on the timeline (e.g., past events, future events).

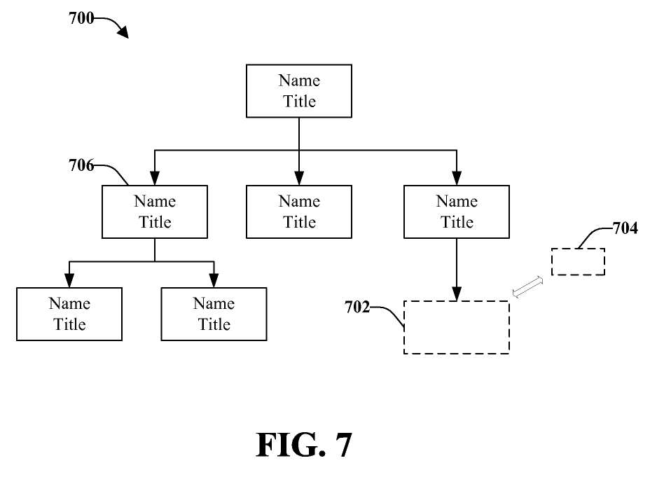

FIG. 7 is another example implementation in accordance with one or more of the disclosed aspects. An organization chart 700 is illustrated, however, the disclosed aspects can be utilized with any type of data or chart (e.g., ancestry chart). Illustrated at 702, is a block that represents a position within the organization chart 700. If the person in that position leaves the company or the job position in that location is eliminated, a visual representation can move that block 702 out of the organizational chart 700 such that the block moves away and becomes smaller, as illustrated at 704, until the block is very small. In accordance with some aspects, the block can completely disappear.

Alternatively or in addition, if a new person is hired or a position is created, the block can start small 704 and move to its location in the chart 700 while becoming bigger, as illustrated at 702. According to another aspect, if a person changes job positions, the move can be represented as starting in a first job position 702, fading out or becoming smaller 704, and then becoming bigger while moving to the new job position, such as at 706. Thus, as a request for a collection of data, such as organizational changes over a specified period of time is received, the relevant employees, represented as blocks, can be displayed as an animation of events (e.g., turnovers, promotions, and so forth). This allows the person viewing the chart to see an animation of the organizational changes.

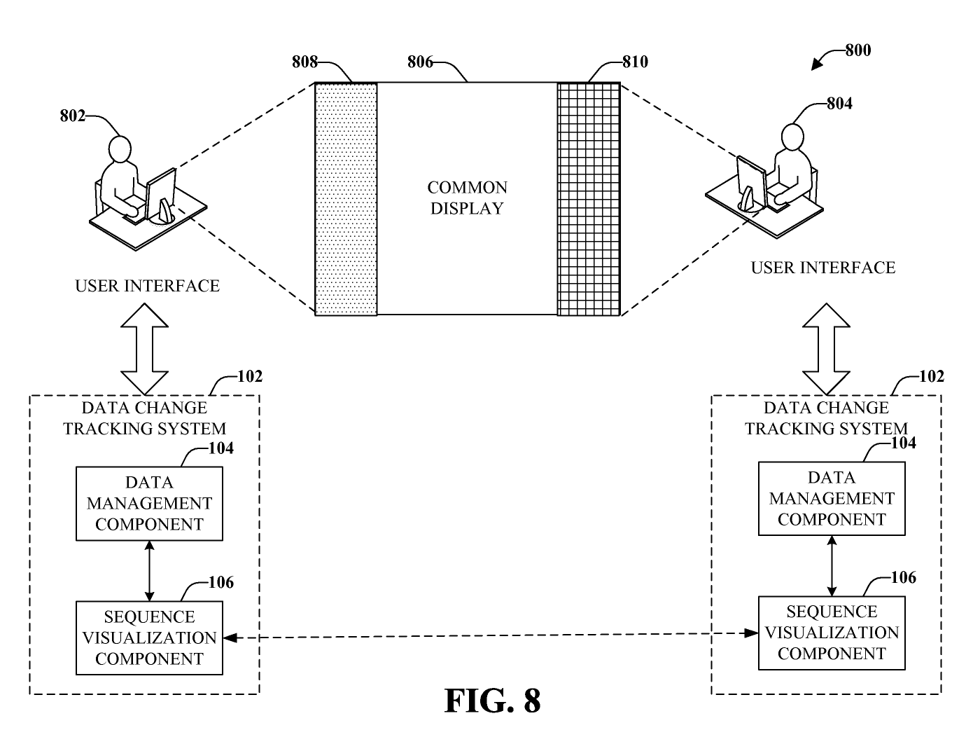

FIG. 8 illustrates a representation of two people visualizing a similar data animation in accordance with the disclosed aspects. As illustrated, a first user 802 and a second user 804 are communicating though respective user interfaces. Each user interface can be associated with separate data change tracking systems 102 that include respective data manipulation components 104 and sequence visualization components 106, which can communicate to each other, as represented by the dashed line. In accordance with some aspects, the user interfaces can share a common data change tracking system 102.

The first and second users 802, 804 (or more users) can perceive a common display area 806. However, there can be portions of a display that are only viewed by the owner of that portion. For example, first user 802 owns or controls private potion 808 while second user 804 controls private portion 810. The respective portions are hidden from view from the other users. Thus, first user 802 cannot view the data in hidden portion 810 and second user 804 cannot view the data in hidden portion 808. Thus, data integrity is maintained when two or more users utilize a common display that allows the users to view their data (both public and private) utilizing a common display. It should be noted that the common display does not have to be a single display but can be separate devices, each displaying common data.

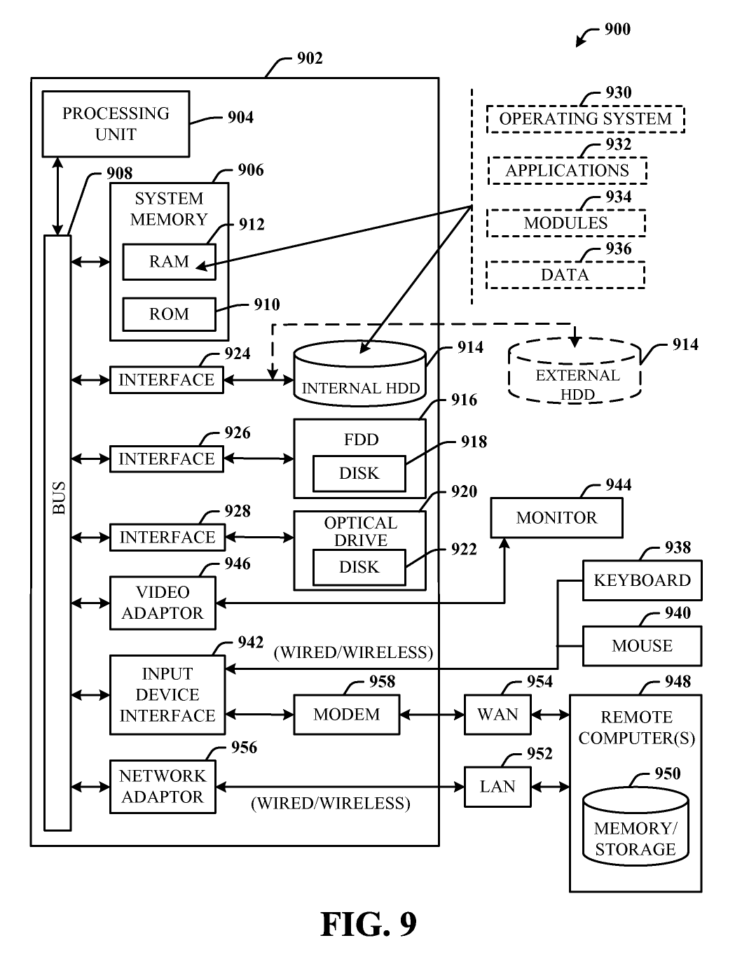

Referring now to FIG. 9, there is illustrated a block diagram of a computer operable to execute the disclosed architecture. In order to provide additional context for various aspects disclosed herein, FIG. 9 and the following discussion are intended to provide a brief, general description of a suitable computing environment 900 in which the various aspects can be implemented. While the one or more aspects have been described above in the general context of computer-executable instructions that may run on one or more computers, those skilled in the art will recognize that the various aspects also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the one or more aspects.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the various aspects can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 through an interface, such as a video adapter 946. In addition to the monitor 944, a computer typically includes other peripheral output devices (not shown), such as speakers, printers, etc.

The computer 902 may operate in a networked environment using logical connections through wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 through the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

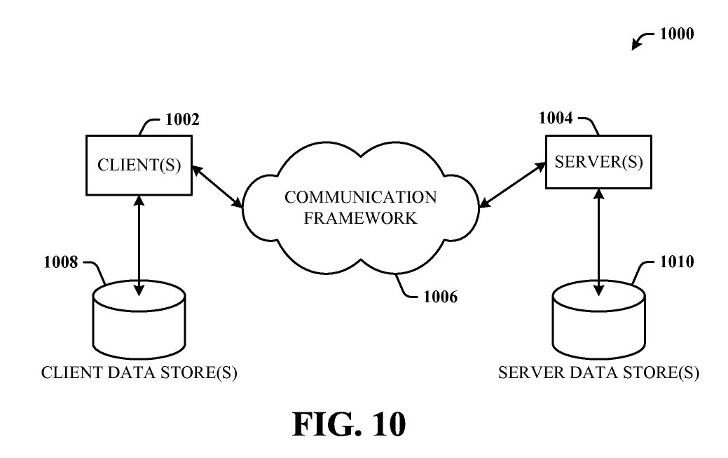

Referring now to FIG. 10, there is illustrated a schematic block diagram of an exemplary computing environment 1000 in accordance with the various aspects. The system 1000 includes one or more client(s) 1002. The client(s) 1002 can be hardware and/or software (e.g., threads, processes, computing devices). The client(s) 1002 can house cookie(s) and/or associated contextual information by employing the various aspects, for example.

The system 1000 also includes one or more server(s) 1004. The server(s) 1004 can also be hardware and/or software (e.g., threads, processes, computing devices). The servers 1004 can house threads to perform transformations by employing the various aspects, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated through a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification intended to embrace all such alterations, modifications, and variations.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods. [00104] In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” The term “or” as used in either the detailed description of the claims is meant to be a “non-exclusive or”.

The word “exemplary” as used herein to mean serving as an example, instance, or illustration. Any aspect or design described herein as “exemplary” is not necessarily to be construed as preferred or advantageous over other aspects or designs.

Furthermore, the one or more aspects may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

What is claimed is:

1. A system that facilitates understanding a sequence of data changes, comprising:
a data manipulation component that gathers modifications relating to a plurality of data; and
a sequence visualization component that outputs the gathered modifications as a function of time in response to a data request.

2. The system of claim 1, the sequence visualization component outputs the gathered modifications as a time-based animation that represents the data at a time prior to the gathered modification and the data at a time after the gathered modification.

3. The system of claim 2, wherein the time-based animation is a flexible and navigatable timeline.

4. The system of claim 1, further comprising a reliance component that associates a level of confidence with each of the plurality of data.

5. The system of claim 1, further comprising a data sharing component that provides a shared display area and at least two private display areas.

6. The system of claim 5, the data in the shared display area is perceived by two or more users and data in each of the private display areas is viewable to a respective user.

7. The system of claim 1, the plurality of data is from a database.

8. The system of claim 1, the plurality of data is documents.

9. The system of claim 1, the plurality of data is text and data.

10. A computer-implemented method of representing data changes as a sequence of visual events, comprising:
accessing a collection of data;
recording changes to a subset of the collection of data; and
using visual animation to provide a history of the recorded changes upon request for the collection of data.

11. The method of claim 10, accessing the collection of data comprises retrieving the collection of data from a database.

12. The method of claim 10, comprising including confidence information with the recorded changes.

13. The method of claim 10, comprising associating related information with the recorded changes.

14. The method of claim 13, the related information is at least one of a user that made the change, an annotation, a motivation for the change, or combinations thereof.

15. The method of claim 10, using animation to provide the history of recorded changes comprising displaying a visual representation of the recorded changes.

16. The method of claim 10, the history of the recorded changes is a sequence of events related to the collection of data.

17. A computer-executable system comprising:
means for receiving a request for a subset of data;
means for obtaining modifications relating to the subset of data; and
means for dynamically presenting the modifications and the subset of data in animated form in chronological order in as a time-based animation that alters a view of the subset of data between a past event and a future event.

18. The computer-executable system of claim 17, further comprising:
means for rendering the subset of data in a shared display that is viewable by two or more users; and
means for rendering the subset of data in at least one private display area that is viewable to one of the two or more users.

19. The computer-executable system of claim 17, further comprising:
means for associating a confidence level with the subset of data.

20. The computer-executable system of claim 17, further comprising:
means for retaining a sequence of modifications over time.
